(19) United States
(12) Patent Application Publication
(10) Pub. No.: US 2018/0297724 A1
(43) Pub. Date: Oct. 18, 2018

(54) EXTENSIBLE SPACE PLATFORM

(71) Applicant: River Front Services, Inc., Chantilly, VA (US)

(72) Inventors: Thomas Jeffrey Harvey, Nederland, CO (US); Ruth Elizabeth Burgess, Oakton, VA (US); Anthony Miles Brown, Sneads Ferry, NC (US); Donald Ray Brown, Oakton, VA (US)

(21) Appl. No.: 15/951,045

(22) Filed: Apr. 11, 2018

Related U.S. Application Data
(63) Continuation-in-part of application No. 15/905,244, filed on Feb. 26, 2018.
(60) Provisional application No. 62/484,368, filed on Apr. 11, 2017.
(60) Provisional application No. 62/626,642, filed on Feb. 5, 2018.

(51) Int. Cl. B64G 99/00; B64G 1/64

(52) U.S. Cl. CPC B64G 9/00; B64G 1/40; B64G 1/646

(57) ABSTRACT

This description relates to an extensible space-based infrastructure platform having modules that can be launched in a stowed configuration, placed in orbit, and then deployed to extend the modules away from each other for an integrated infrastructure platform configuration. This infrastructure platform provides power, timing, communications, data management, attitude control, and other vital and non-vital services to docked payloads. Multiple payloads can be launched into orbit, maneuvered into position, and docked with the space-based services platform. Each docked payload utilizes the infrastructure of the space-based services platform and its interconnected network of docked payloads. Multiple space-based platforms can be docked together to provide a larger space-based infrastructure platform with a broader array of services available to all docked payloads and users.

### CROSS REFERENCE TO RELATED APPLICATIONS

This application claims priority to U.S. Provisional Patent Application No. 62/484,368 filed Apr. 11, 2017 and titled “Space Station Formed of Multiple Mini-Stations to Provide On-Orbit Support for Payloads” and to U.S. Provisional Patent Application No. 62/626,642 filed Feb. 5, 2018 and titled “Space Station Formed of Multiple Mini-Stations.” This application claims priority to U.S. patent application Ser. No. 15/905,244 filed Feb. 26, 2018 and titled “Structural Tape Deployment Apparatus.” The entire contents of each of the above-identified priority applications are hereby fully incorporated herein by reference.

### TECHNICAL FIELD

The invention described herein relates to a space platform and more particularly, to a space platform formed of multiple mini-platforms that provides on-orbit infrastructure, services, support, and replacement for space-based capabilities, services, and appliances.

### BACKGROUND

A major impediment to organizations that desire to use earth-orbiting satellites to collect data for business purposes or science is that the conventional solution is costly, lengthy, and technically difficult. For instance, deploying a synthetic aperture radar to survey post hurricane damage requires hiring a company or staff to design a custom satellite, obtaining frequency allocations and licenses for communications, buying space on a launch vehicle, building a ground station to manage and command the satellite, developing a ground infrastructure to download and manage the collected data; and finally launching and operating the satellite and all related systems. This effort takes two or more years at best just to get to the launch point.

Additionally, the conventional cost of market entry of such a program is tremendous and the technical risk is extremely high. For instance, a conventional 12 U CubeSat spacecraft, probably the most technically minimal platform for such a mission, costs $10M or more. However, being able to afford the cost only introduces a company to the real problem that commonly plagues conventional systems, which is that custom space appliances only deteriorate from the moment of build lock-down and once in orbit are subject to component malfunction and system failure. Of the conventional systems that make it to orbit, only 20.4% achieve fully mission capable status. More than 36% either fail upon arrival or never get into space because of technical issues. Of those that make it into orbit, a full 67.7% are dead on arrival, have early failure, or do not meet basic mission objectives.

Thus, conventional space systems are developed as custom appliances at great expense and risk to their stakeholders. Once on orbit, capability does not exist to repurpose, refresh, or repair these systems, and they quickly become obsolete. When their fuel is depleted and/or payloads fail, these systems become useless (maybe even a liability), and the investment in their development is lost. The exorbitant costs and complexity associated with satellite development imposes significant barriers to entry for those desiring to participate in the space enterprise.

The conventional “New Space” effort of using small satellites, below 100 Kg and often below 40 Kg, to exploit technology and sensors at a lower cost has done little to make space more accessible, more usable, or more cost conscience. The cost of market entry of such programs is tremendous, and the technical risk is extremely high. Once on orbit, problems that “New Space” vehicles experience, such as, system failure, operating system failure, single event upset/latchup, data downlink issues, storage management, power management, timing, and command and telemetry, render the vehicle disabled.

Conventional space vehicles/systems are designed for a particular mission, with specific operating parameters, such as duty cycle, power management, data communications, timing, and other parameters. If any need arises to operate outside of those parameters, the operating life of the system is reduced. For example, if a system has a design duty cycle of 30% and a need arises to increase the duty cycle to 50%, the operating life of the system is reduced significantly. The operating life of system components is a factor in the overall system operating life. Operating system components above the design parameters reduces the overall system operating life.

To withstand the harsh space environment, conventional space vehicles/systems include many redundancies. For example, a system may include multiple processors. If one processor malfunctions, the system switches to a different processor. However, each processor is the available processor at time of system design. Accordingly, each processor may be three to five years old at the time of launch. Conventional systems do not include any manner to replace or upgrade operating system components, much less entire systems, to extend the operational life. While a manned space mission and corresponding manned space walk may be able to launch repair parts to space to execute a system repair of an orbiting vehicle, such conventional methods are cost prohibitive.

Conventional systems that receive and transmit data require both receive and transmit capability and components. These components must be positioned to minimize interference and/or to minimize alternating operation. To achieve this positioning, large booms may be extended from a single satellite to separate the antennas, or a vehicle must be built large enough to achieve this separation based on size of the craft.

Conventional space platforms require manual assembly. Component parts are transported to orbit. Then, manned-space walks are required to assemble the components into a space platform.

### SUMMARY

This description relates to an extensible space platform having modules that can be launched in a stowed configuration, placed in orbit, and then deployed to extend the modules away from each other for an operational configuration. These modules provide power, communications, data management, attitude control, and other services to the space platform. Multiple payloads can be launched into orbit, maneuvered into position, and docked with the space platform. Each docked payload utilizes the infrastructure of the space platform and each docked payload. Multiple space platforms can be docked together to provide a larger space platform.

These and other aspects, objects, features, and advantages of the invention will become apparent to those having ordinary skill in the art upon consideration of the following detailed description of illustrated examples.

### BRIEF DESCRIPTION OF THE DRAWINGS

FIG. 1A depicts a module of an extensible space platform, in accordance with certain examples.

FIG. 1B depicts a cut-away section of the module of the extensible space platform showing interior components of the module, in accordance with certain examples.

FIG. 2 depicts an extensible space platform comprising three modules in a stowed configuration for launch, in accordance with certain examples.

FIG. 3 depicts the extensible space platform in the initial transition from the stacked configuration of the modules to a coplanar configuration of the modules, in accordance with certain examples.

FIG. 4 illustrates the extensible space platform in the coplanar configuration of the modules as the modules are being extended away from each other to the operational position, in accordance with certain examples.

FIG. 5 depicts a fully deployed extensible space platform formed of three modules in a triangular configuration, in accordance with certain examples.

FIG. 6 depicts a payload delivery vehicle assembly in a stowed/launch configuration, in accordance with certain examples.

FIG. 7 depicts a sun-side view of a deployed payload that is a power storage, generation, and communication enhancement to an extensible space platform, in accordance with certain examples.

FIG. 8 depicts an earth-side view of the deployed payload that is a power storage, generation, and communication enhancement to an extensible space platform, in accordance with certain examples.

FIG. 9 depicts three payloads docked to an extensible space platform, in accordance with certain examples.

FIG. 10 depicts docking of a single customer payload to a single docking port of a module of an extensible space platform, in accordance with certain examples.

FIG. 11 depicts docking of multiple extensible space platforms together to create a larger space platform, in accordance with certain examples.

FIGS. 12-15 depict a sequence of maneuvering payloads to replace a payload on orbit with a standby payload that is also on orbit, in accordance with certain examples.

### DETAILED DESCRIPTION

Turning now to the drawings, in which like numerals represent like (but not necessarily identical) elements throughout the figures, the innovations are described in detail.

This description relates to an extensible space platform having modules that can be launched in a stowed configuration, placed in orbit, and then deployed to extend the modules away from each other for an operational configuration. These modules provide power, communications, data management, attitude control, and other services to the space platform. Multiple payloads can be launched into orbit, maneuvered into position, and docked with the space platform. Each docked payload utilizes the infrastructure of the space platform and each docked payload. Multiple space platforms can be docked together to provide a larger space platform.

The innovations described herein, can reduce time to market by up to 50% or more, can lower upfront costs through the reutilization of well-defined specifications, and can reduce technical risks by providing Infrastructure as a Service (IaaS) on orbit. These innovations may eliminate up to 54% or more of all failure risk and up to an additional 34% or more of technical risks, which are due to electrical subsystem failure. These innovations manage such risks using well-defined interfaces and preflight testing using an on-orbit physical model.

In the next few years, space “real estate” will become critical to the success of future missions. The innovations described herein can mitigate this real estate risk for customers by providing a leasable spot on a miniature, extensible space platform for their instrument or payload to reside during its operational life. Once under contract, the tenant company has only to meet well-defined engineering requirements for their payload or instrument to interface with the miniature space platform and then turn the payload or instrument over to the leasing company for delivery on orbit. The leasing company will manage everything from this point forward up to and including the delivery of the data to the customer on the ground. This management includes integrating the payload and securing it to a transport spacecraft called a Payload Delivery Vehicle (PDV) to form a Payload Delivery Vehicle Assembly, managing launch, and other on orbit aspects.

After launch of the rocket taking the payload into orbit near the space-based platform, the Payload Delivery Vehicle Assembly (PDV-A) is released from the launch vehicle and acts as a taxi to bring the payload to the space-based platform and to dock the payload with the space-based platform. The space-based platform is the interconnecting infrastructure and manages the system's overall services (power, timing, orbital location, communications, earth orientation, computational resources, etc.) needed to support and operate the full capabilities of the docked payloads. At the end of the payload's operational life, the payload can be jettisoned and de-orbited, sold or sub-leased to another user, or turned over to the space platform's owner. Space-based platform portals that are vacated can be reoccupied by docking a PDV with a new or updated appliance/payload to the space-based platform.

The innovations described herein include using a 12 U CubeSat volume or other larger extensible launch volume to form a much larger, flat, triangular (or other shape) space-based infrastructure platform that can then dock with other platforms to form a larger infrastructure platform, as well as the model of providing Infrastructure as a Service (IaaS) in space. When the PDV is docked to a space-based platform, the sum of the two resources provides the payload with the services it requires, when it requires them. The PDV's batteries, solar arrays, thrusters, and computer(s) are connected to the space-based platform's systems, adding to the overall platform's capabilities, services, and infrastructure. The innovations can extend the orbital life of payloads and can ease compliance with emerging policies that restrict payload and appliance life, minimize debris, and establish orbits.

The innovations described herein provide Infrastructure as a Service (IaaS) on orbit for space-based sensors and creates a platform from which other services can be provisioned. The innovations include a high expansion ratio spacecraft that includes a common bus, a payload interface control, an expansion mechanism, and multiple payloads. This construct is the baseline of an expandable, resilient, upgradable space platform that is sensor agnostic and is a service multiplier. A single space-based platform can connect six or more payloads via an extensible framework. The space-based platform can host the Payload Delivery Vehicle Assembly as a payload, a sensor, an infrastructure support appliance (for example, batteries, solar arrays, memory, storage, etc.), and/or other payloads. Multiple space-based platforms can be combined into a single, fully networked platform. This space-based platform provides common bus type services such as power, communications, propulsion, precision timing, attitude control, data management, processing, command and control, and other commonly required services for all hosted sensors, payloads, appliances, and platforms.

This concept of using a small extensible common bus structure to form a larger interconnected spacecraft that provides services, vital and non-vital, to other connected spacecraft, payloads, and sensors is new. Creating a services infrastructure on-orbit by providing a software defined network (SDN) of platforms that deliver basic services for operations in space (such as power, memory, data storage, timing, attitude control, telemetry, commanding, and communications) has never been achieved previously by conventional systems. Additionally, the aggregated infrastructure, in either a single extended platform or multiple connected platforms can provide enhanced services such as, processing, analysis, extended storage, data handling, propulsion, enhanced power, and networking on a service-for-fee construct using Service Level Agreements (SLA) or other metered agreement. When a payload assembly is docked to a platform, the sum of the resources of the payload assembly and platform becomes available for all interconnected devices. The payload assembly's batteries, solar arrays, thrusters, master clock, memory, storage, computer(s), and other resources are networked to the larger platform's systems, adding to the overall platform's capabilities and infrastructure. This space-based platform construct creates an on-orbit infrastructure that is resilient, refreshable, repurposeable, and replaceable, thereby extending the orbital life of connected payloads and on-orbit systems. This space-based infrastructure construct also eases compliance with emerging policies that restrict spacecraft life, minimize debris, and establish orbits by managing the deorbit of exhausted and failed payloads and systems.

One aspect of the “Payload Delivery Vehicle” is that the PDV is a transport system, which is a minimally capable micro-spacecraft in itself. The PDV has a defined and published interface specification from which tenants are able to design their payloads to conform. This design allows the space-based infrastructure platform to host any sensor or payload that meets the interface requirements of the PDV. Thus, the space-based platform is agnostic to its payload or appliance as long as it meets the PDV's interface requirements. After a payload, appliance, or other sensor is delivered and integrated to the PDV, it is ready for launch.

Once released from the launch vehicle, such as a rocket, the PDV ferries the tenant's payload to a space-based platform and docks. The combination of the PDV and the payload or appliance is referred to as a Payload Delivery Vehicle Assembly (PDV-A). Once docked to the space-based platform, the payload now has access to the platform's infrastructure, services and capabilities. Basic services, such as power, orbital location, attitude control, propulsion, system time, commanding, earth orientation, and other operational services required to operate, are supplied by the platform as part of the basic services. Additionally, platforms can provide enhanced services, such as extended storage, advanced processing, time sensitive communications, extra bandwidth, and other non-critical services for a fee through a service level agreement (SLA) or some other metered pricing construct. At the end of the payload's operational life, the Payload Delivery Vehicle Assembly can be jettisoned from the platform for a controlled de-orbit, sold, sub-leased to another user, replaced, or given to the space platform's owner. This construct creates the first rentable real estate in space and allows data collectors, scientists, and governments to rent a docking slot (port) based upon need. This construct allows tenants and platform owners to manage on-orbit capabilities, real estate, and assets more dynamically and economically.

The Payload Delivery Vehicle is the base unit of the space-based platform design. A Payload Delivery Vehicle is a spacecraft on its own that includes power generation, power distribution, attitude control, propulsion, timing, docking system, communications, and a payload interface system. The payload interface and platform to payload network is managed through the docking system. A space-based platform can include a single PDV volume based upon the needs of the customer.

A basic extensible space-based platform comprises three or more modules, with each module being connected to at least two other modules by an extensible framework to form a base triangular construct. In the launch configuration, the extensible framework is retracted, and the system occupies a minimal volume for launch. Once in orbit, the extensible framework is extended to move the modules away from each other for the operational configuration. A platform comprising three modules forms a triangle when extended. A platform comprising four modules may form a pyramid or square shape when extended. Two or more platforms can be sandwiched together one on top of the other to form a deeper and stiffer infrastructure construct. Additionally, multiple platforms may be connected together after deployment to create larger multi-platform infrastructures.

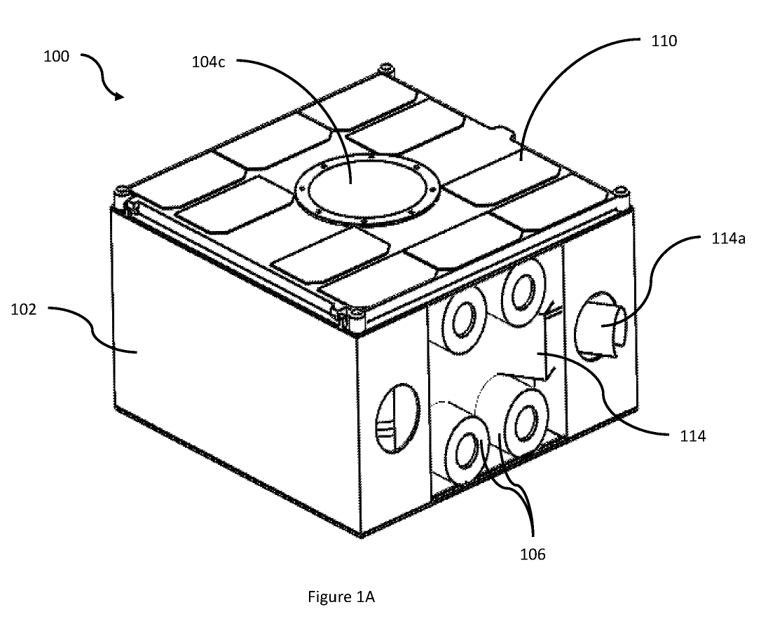

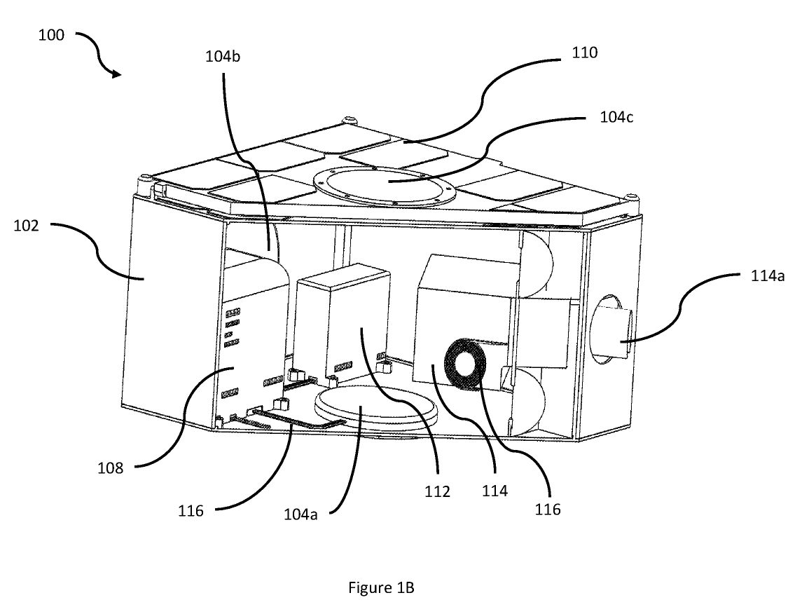

A module of an extensible space platform will not be described with references to FIGS. 1A and 1B. FIG. 1A depicts a module 100 of an extensible space platform, in accordance with certain examples. FIG. 1B depicts a cut-away section of the module 100 of the extensible space platform showing interior components of the module, in accordance with certain examples. As shown in FIGS. 1A and 1B, the module 100 comprises a housing 102 that provides a structural framework and enclosure for the module 100 and that supports the other components of the module 100.

The module 100 further comprises at least one docking port 104. As depicted in FIGS. 1A and 1B, the module 100 comprises three docking ports 104a, 104b, and 104c. Docking port 104a is a “nadir” port that faces toward Earth in orbit. Docking port 104c is an “anti-nadir” port that faces away from Earth in orbit. Docking port 104b is an exterior port that faces away from an interior of the extensible space platform when deployed.

The module 100 further comprises a propulsion system 106 to maneuver the extensible space platform. The propulsion system 106 can maneuver the extensible space platform prior to deployment to locate the extensible space platform on station, and thereafter the extensible space platform can expand its extensible framework to deploy the modules 100. The propulsion system 106 also can maneuver the extensible space platform after deployment to fine tune or otherwise maintain an orbit or position, or to provide attitude control to the extensible space platform.

As depicted in FIGS. 1A and 1B, the propulsion system 106 comprises four ion thrusters of an ion propulsion system, but can be comprised of other types of propulsion as desired. The propulsion system 106 is controlled by a processor 108 that receives attitude information and operates the propulsion system 106 to achieve/maintain a desired location/attitude of the extensible space platform.

The module 100 further comprises a deployable solar array 110 coupled to a rechargeable power source 112 to provide power to the extensible space platform. In orbit, the processor 108 can control the deployable solar array 120 to deploy the solar array 110 for operation. The solar array 110 charges the rechargeable power source 112, which can be one or more batteries.

The module 100 further comprises a structural tape deployment apparatus 114 as an extensible framework. The extensible framework is a structural member connecting two modules 100 together. The extensible framework is retracted to move the modules 100 close to each other for a stowed/launch configuration. In orbit, the extensible framework is extended to move the modules 100 apart for an operational configuration. The extensible framework provides a rigid structure when extended. The rigid structure forces the modules 100 apart when extended and maintains the extended configuration of the extensible space platform.

As shown in FIGS. 1A and 1B, the extensible framework is a structural tape 114a of a structural tape deployment apparatus 114. The structural tape deployment apparatus 114 comprises a housing attached to the housing 102 of a first module 100, and an extendable end of the structural tape 114a is attached to another module 100. The structural tape deployment apparatus 114 further includes a tape drive mechanism disposed within the structural tape deployment apparatus housing. The tape drive mechanism drives the structural tape 114a from a rolled/retracted position to an extended position by operation of a drive motor controlled by the processor 108 and/or one or more electrical circuits. The structural tape 114a may be referred to herein as either structural tape or tape. As the drive motor drives the tape 114a from the rolled position to the extended position, the tape 114a transitions from a flat, rolled state inside the structural tape deployment apparatus housing to an extended, curved state outside the structural tape deployment apparatus housing.

In the rolled position, the tape 114a is flat and wound in a cylindrical shape. In the extended position, the tape 114a is extended in a direction away from the module housing 102. In the extended position, the tape 114a may have a curved shape that provides rigidity for the extended tape 114a as it extends from the structural tape deployment apparatus 114.

The tape 114a may be a composite tape comprised of graphite, fiberglass, or other suitable materials or combinations thereof. The composition of the tape 114a is chosen to achieve a desired strength and stability of the tape 114a based on a specified application for the tape. The tape 114a can be stable in both the rolled position and the extended position. In the rolled position, the tape 114a is stable such that it does not have interior forces inducing the tape 114a to expand. In the extended position, the tape 114a is straight and rigid, which may provide an extension force and/or a structural force for a module 100 coupled to the structural tape deployment apparatus 114. The tape 114a can comprise any suitable material that allows winding the tape 114a into the rolled position and extending the tape 114a into the extended position to provide a suitable strength and stability of the extended tape 114a for its application.

In the extended position, the tape 114a comprises a curved profile. However, the tape 114a may comprise any suitable profile that achieves the desired strength and stability of the extended tape 114a for its application. For example, the profile may be 90 degrees, 180 degrees, or 270 degrees of a circle, or any suitable profile in a range of 45 degrees to 360 degrees or more.

The processor 108 controls extension of the extensible framework. The processor 108 actuates the motor of the structural tape deployment apparatus 114 to extend the structural tape 114a. Electrical circuits and/or the processor 108 control deactivating the motor to stop extending the structural tape 114a. The structural tape deployment apparatus 114 may include one or more mechanical stops that prevent retraction of the structural tape 114a after extension to maintain the extended structure of the extensible space platform.

As shown in FIGS. 1A and 1B, the module 100 comprises a single structural tape deployment apparatus 114 coupled to the housing 102 and having an opposite end of the structural tape 114a coupled to another module 100 (not depicted in FIGS. 1A and 1B). Each module 100 of the extensible space platform may be similarly configured. Alternatively, one module 100 may comprise multiple structural tape deployment apparatus 114, where each has an opposite end of the corresponding structural tape 114a coupled to a separate module 100. In this case, certain modules 100 of the extensible space platform may not comprise a structural tape deployment apparatus 114 and will only include a termination point of at least one structural tape 114a.

Other suitable extensible framework may be used in place of the structural tape deployment apparatus 114. For example, the extensible framework may be extensible mast assemblies as described in U.S. Provisional Patent Application No. 62/626,642 filed Feb. 5, 2018 and titled “Space Station Formed of Multiple Mini-Stations.”

The module 100 further comprises a wiring harness 116 coupled to the power source 112, the processor 108, the docking ports 104a-c, the extensible framework (such as the structural tape deployment apparatus 114), and any other components of the module 100. The wiring harness 116 extends to each module 100 of the extensible space platform. The power source 112, processor 108, and wiring harness 116 are coupled to each docking port 104a-c via one or more connectors at each docking port 104a-c. The wiring harness comprises data and power conductors to conduct data and power between modules 100 and any payloads docked to the modules 100. In this manner, each module 100 is interconnected to the power source 112, processor 108, and any payload coupled to docking ports 114a-c of the module 100 and any other module 100 of the extensible space platform. The wiring harness 116 can be coiled when the extensible space platform is in the retracted configuration for launch (as shown at the structural tape deployment apparatus 114 in FIG. 1B) and can uncoil as the modules are extended to the operational configuration of the extensible space platform. The wiring harness 116 also can be constructed as an integral harness built into the composite tape 114a, for example, by coupling one or more conductors to the tape 114a and rolling the conductors with the tape 114a. The conductors can be attached to or embedded in the tape 114a. In this case, the wiring harness 116 is also extended as the tape 114a is extended.

Each module 100 can be configured as desired for a particular operation of the extensible space platform. For example, each module 100 may not employ all of the components depicted in FIGS. 1A and 1B. The module 100 may comprise fewer or more docking ports 114. Each module 100 may not comprise the deployable solar array 110 and/or the rechargeable power source 112. A solar array 110 on one module 100 may supply power to multiple modules 100 of the extensible space platform and/or to multiple rechargeable power sources 112 of other modules 100. Additionally, a rechargeable power source 112 of one module 100 may supply power to multiple modules 100 of the extensible space platform. Furthermore, each module 100 may not include or utilize a propulsion system 106. While all modules may comprise a propulsion system 106, a propulsion system 106 on one module 100 of the extensible space platform (or fewer than all modules 100) may be sufficient for attitude control/positioning of the extensible space platform.

The processor 108 may be one or more computing devices and/or a computing system comprising multiple computing devices. The computing devices can comprise one or more processors, memory, wired and wireless networking and communication components, software, hardware, and any other suitable computing component. The processor 108 together with the other components of the module 100 (and of multiple modules 100 connected to the extensible space platform) control power, communications, propulsion, precision timing, attitude control, data management, processing, command and control, and other services for the extensible space platform and all hosted sensors, platforms, and other payloads.

Although not depicted for each component of the module 100 in FIGS. 1A and 1B, the various components are fixed to the housing 102 or other component attached to the module 100. The various components also are interconnected electronically via the wiring harness 116 or other conductors to distribute power, control, communications, and other data to the components.

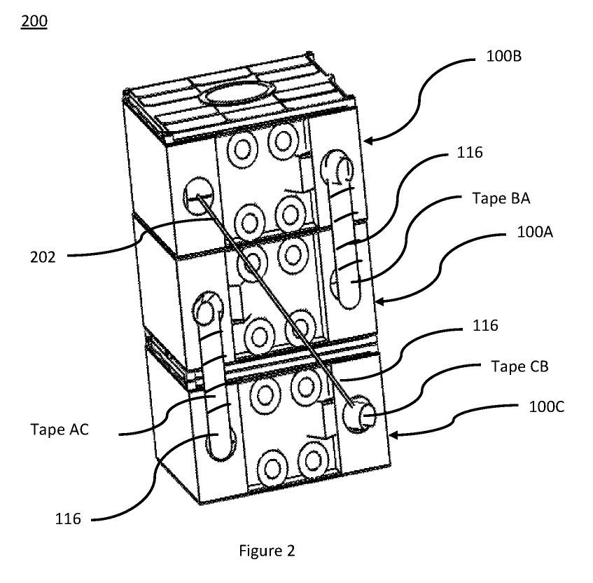

FIG. 2 depicts an extensible space platform 200 comprising three modules 100A, 100B, and 100C in a stowed configuration for launch, in accordance with certain examples. As shown in FIG. 2, the modules 100A-C are stacked to minimize a launch volume of the components of the extensible space platform 200.

The modules 100A-C are connected to each other via the extensible framework. As depicted in FIG. 2, the extensible framework comprises structural tapes. Module 100A comprises a structural tape deployment apparatus 114 (FIGS. 1A and 1B) comprising a structural tape 114a (FIGS. 1A and 1B) that extends from module 100A to module 100C and is coupled to module 100C. The structural tape 114a extending from module 100A to module 100C is referenced in FIG. 2 as “tape AC.”

Module 100B comprises a structural tape deployment apparatus 114 (FIGS. 1A and 1B) comprising a structural tape 114a (FIGS. 1A and 1B) that extends from module 100B to module 100A and is coupled to module 100A. The structural tape 114a extending from module 100B to module 100A is referenced in FIG. 2 as “tape BA.”

Module 100C comprises a structural tape deployment apparatus 114 (FIGS. 1A and 1B) comprising a structural tape 114a (FIGS. 1A and 1B) that extends from module 100C to module 100B via a retractable lanyard 202. The structural tape 114a extending from module 100C to module 100B via the retractable lanyard 202 is referenced in FIG. 2 as “tape CB.”

In the stowed position, the extension end of tape AC remains in module 100C or extends less then the complete distance to module 100B. A lanyard 202 is connected on one end to the extension end of tape CB and on another end to a motor-controlled reel (or spring-loaded and driven reel) (not depicted in FIG. 2) attached inside module 100B. In operation, the reel is operated to turn the reel, thereby winding the lanyard 202 on the reel. As the lanyard 202 is wound on the wheel, it guides the extending tape CB from module 100C to module 100B. When tape CB reaches the desired location at module 100B, the reel is stopped to fix the extension end of tape CB to module 100b. The extension end of tape CB may wind one or more revolutions on the reel to securely fix the extension end of tape CB to module 100B. Alternatively, tape CB is retracted onto a fitting conforming to the cross section of the tape on module 100B. The reel is over retracted slightly compressing the tape end into the fitting attached rigidly to module 100B. By overloading the tape to the fitting to a load in excess off any on-orbit load that may occur, the desired stiffness in axial and bending of the tape is obtained, much like gluing the tape to the fitting. An alternative method of attaching tape CB to module 100B is to use a latching hinge at the module C end of tape CB that is attached to a bar that is attached to a latching hinge at module B. Upon initial deployment of the three modules the two latching hinges would latch open as tapes AB and AC are deployed to the length of the BC hinge and bar assembly.

The wiring harness from module 110C to module 110B can be prepositioned and connected between modules 100C and 100B prior to launch. Alternatively, extension of tape CB in module 100B can also seat the wiring harness 116 into corresponding connectors in module 100B to complete the circuit of the wiring harness 116.

The lanyard 202 is optional, and the tape CB may be connected from module 100C to module 110B prior to launch, similarly to the other tapes AC and BA.

Various sizes and numbers of the modules 100A-C can be chosen to create a desired size and configuration of the extensible space platform 200. For example, the stowed extensible space platform can utilize a single 12 U CubeSat volume. In this case, each module 100A-C can comprise dimensions of approximately 23 cm×23 cm×12 cm such that the stacked modules 100A-100C comprise the 12 U CubeSat volume. When in the stowed configuration, the three modules 100A-C stack on each other to form an approximately 23 cm×23 cm×36 cm block. Then, the extensible space platform 200 in the stowed configuration is slid into a CubeSat dispenser. The dispenser is attached to a launch vehicle (for example, a rocket) that places the stacked assembly into an earth orbit. Once on orbit, a door on the dispenser is opened by an electric signal, and a spring within the dispenser ejects the extensible space platform 200 comprising the stack of modules 100A-C into space. The extensible space platform 200 may be loaded into a launch vehicle without use of a dispenser and may be ejected from the launch vehicle in orbit via any suitable manual or mechanical actuation.

Other suitable sizes of the modules 100A-C and the corresponding extensible space platform 200 can be utilized. The size of the modules 100A-C can be selected such that the stowed configuration meets the nominal volume of a corresponding container/dispenser for launch and/or meets the size for mission requirements. For example, a volume larger than a 12 U volume may be utilized, and the modules 100A-C and the corresponding extensible framework may comprise a desired larger volume.

Shortly after ejection, the modules 100A-C are commanded to separate from each other by a radio signal. For example, the processor 108 can actuate mechanical latches to release the modules 100A-C from each other.

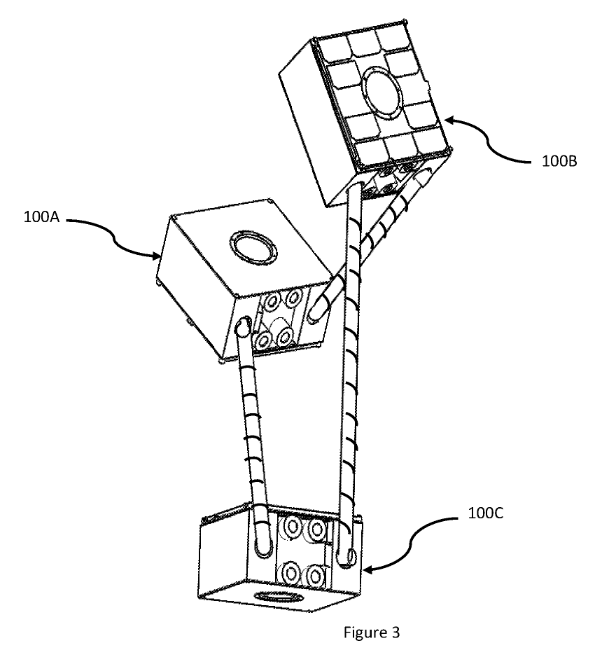

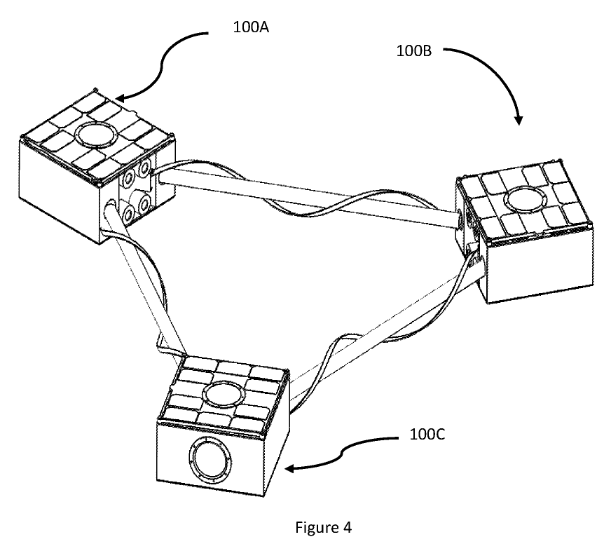

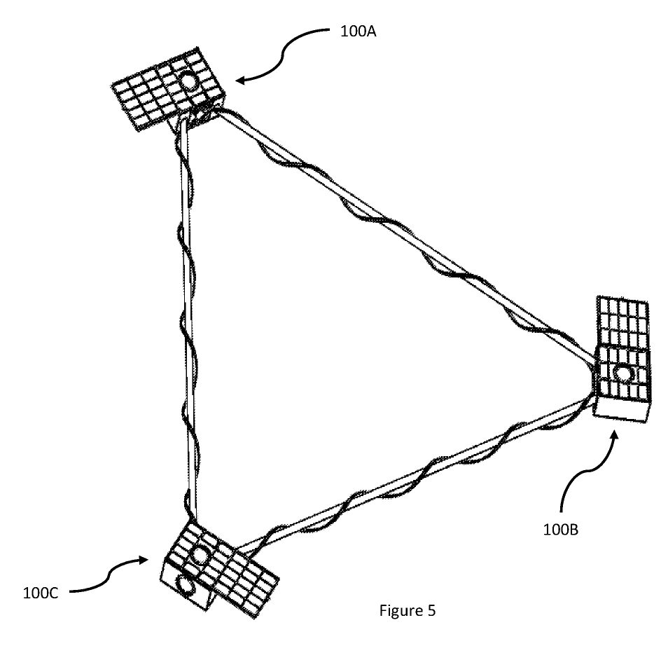

FIG. 3 depicts the extensible space platform 200 in the initial transition from the stacked configuration of the modules 100A-C to a coplanar configuration of the modules 100A-C, in accordance with certain examples. FIG. 4 illustrates the extensible space platform 200 in the coplanar configuration of the modules 100A-C as the modules A-C are being extended away from each other to the operational position, in accordance with certain examples. FIG. 5 depicts a fully deployed extensible space platform 200 formed of three modules 100A-C in a triangular configuration, in accordance with certain examples.

In certain aspects, the deployment kinematics function as follows, with reference to FIGS. 2-5. The tapes from module 100B to module 100A (tape BA) and from module 100A to module 100C (tape AC) elastically straighten or pivot, forming two sides of a triangle and rigidly connecting all three modules 100A-C. The lanyard 202 from module 100C to module 100B forms the third side of the triangle. The lanyard 202 allows the three modules 100A-C to move freely as the two fully connected tapes BA and AC extend. The reel in module 100B is retracted to retract the lanyard 202 into module 100B as the tape CB from module 100C is extended. The lanyard 202 seats the end of the tape CB into module 100B forming a rigid cantilever end condition, and the tape CB is fully extended.

In certain aspects, for a 12 U CubeSat volume version, the 23 cm×23 cm faces of the modules 100A-C are coplanar with the triangle, and one side of each module is at a normal to an axis of the triangle that runs from the triangle's geometric center to a corner. The operation is similar with any sized version of the modules. Once formed, the small triangle is then expanded by extending the three tapes AC, CB, and BA axially until the tapes AC, CB, and BA are fully extended, as depicted in the transition from FIG. 4 to FIG. 5.

As depicted in the transition from FIGS. 2-5, the wiring harness 116 is extended with the tapes AC, CB, and BA to allow data and power to be transferred among the modules 100A-C.

As further depicted in FIG. 5, the deployable solar arrays 110 of one or more of the modules 100A-C are deployed to an operational position. Additionally, the propulsion systems 106 of one or more of the modules 100A-C can be activated to position and/or maintain an orbit/attitude of the extensible space platform 200. The propulsion systems 106 can be operated individually or in parallel to position the extensible space platform 200. Additionally, one or more of the processors 108 of one or more of the modules 100A-C can control operation of the various propulsion systems 106 based on internal operational computer instructions or external commands received from a mission control or other command computer system.

Once the tapes are fully extended, the extensible space platform 200 is now ready to be populated by attaching one or more customer payloads to the docking ports 104 of the modules 100A-C.

Payload delivery vehicles (each a “PDV”) used to transport a customer payload from a launch vehicle to the extensible space platform to dock the payload with the extensible space platform. The PDV is a “low-cost” transport vehicle from the laboratory to the on-orbit extensible space platform that has defined and published specifications to which the tenant/customer can design required power, data, and other interfaces to common connectors to interface with the PDV and the extensible space platform's docking ports, systems, and network.

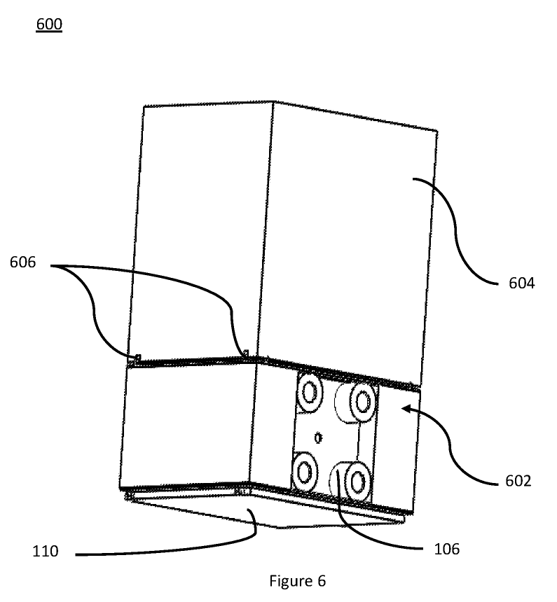

FIG. 6 depicts a payload delivery vehicle assembly (a “PDV-A”) 600 in a stowed/launch configuration, in accordance with certain examples. The PDV-A 600 comprises a payload delivery vehicle (“PDV”) 602 coupled to a payload 604.

The PDV 602 can be similar to the module 100 described previously with reference to FIG. 1. The PDV 602 may include one or more components such as housing 102, docking ports 104, propulsion system 106, processors/computer systems 108, deployable solar array 110, power source 112, and wiring harness 116. If desired, the PDV 602 also may include an extensible framework 114.

FIG. 6 depicts the payload 604 in a stowed configuration for launch. The payload 604 is coupled to the PDV 602. The payload 604 can comprise a docking port configured to dock with a corresponding docking port 104 of the PDV 602. The docking ports are not visible in FIG. 6. The PDV 602 may further or alternatively include mechanical fasteners 606, such as bolts, latches, or other suitable fasteners, to secure the payload 604 to the PDV 602. The PDV 602 may be designed with a specified bolt pattern to accept any payload 604 designed to attach to the specified bolt pattern. Additionally, the PDV 602 may be designed with a specified power and communication bus and/or harness to accept any payload 604 that is designed to connect to the specified bus/harness.

Each docking port 104 (with reference to FIGS. 1 and/or 6) can comprise a coupling mechanism to attach a PDV-A600 to the extensible space platform 200. For example, a docking port 104 can comprise a magnetic capture docking system. The PDV 602 is actuated to move the PDV-A600 to a close proximity to a module 100 of the extensible space platform 200. The PDV-A600 is maneuvered to bring a docking port on the PDV 602 and payload 604 into alignment and close proximity to the docking port 104 on the module 100 of the extensible space platform. Then, an electromagnet on the docking port 104 of the module 100 of the extensible space platform 200 is actuated to magnetically pull the PDV-A 600 to the docking port 104 to dock the components together. The docking port of the PDV-A also may have a corresponding electromagnet that is actuated to provide additional magnetic force to pull the components together. Mechanical fasteners, such as mechanical latches, are then actuated to secure the PDV 602 to the module 100, and the electromagnet(s) is deactivated. Alternatively, once the large electromagnet causes docking and is de-energized, one or more smaller permanent magnets may be used to hold the docking port of the module 100 to the docking port of the PDV 602. The docking procedure couples the PDV 602 to the extensible space platform 200 and further connects the payload 604 to the power, computing, and communication distribution system of the extensible space platform 200. The docking procedure connects the wiring harness 116 of the module 100 of the extensible space platform 200 to a corresponding wiring harness of the PDV 602. Power conductors of the wiring harness can be coupled using contacting connectors for power transfer. Data conductors can be connected via non-contacting RF connectors or mechanical connectors.

When the payload 604 is secured to the payload delivery vehicle 602 via mechanical fastening, the payload 604 is connected to all required components of the PDV 602. Thus, while the payload 604 may include its own power, processing, communication, or other components/capability, the payload 604 can access and utilize needed or additional systems of the PDV 602 and when docked to an extensible space platform 200 all required or needed components within that network. The corresponding wiring harnesses provide the interconnection between the payload 604 and the various components/systems of the PDV 602. Additionally, when the PDV-A600 docks with the extensible space platform 200, the payload 604 and the PDV 602 are further connected to the network and systems/components available from the extensible space platform modules 100, as well as other appliances and devices docked to the extensible space platform 200.

Each docking port allows the docked system to connect to the extensible space platform's network and power distribution system. This interconnection then creates a larger network between the docked system and the extensible space platform's system, which can leverage all the assets of both the docked structure and the larger space platform. In and of itself, a single extensible space platform 200, or multiple connected extensible space platforms 200, without additional payloads or sensors, is a fully functional communications platform. This extensible space-based platform provides data handling and commanding capabilities as an integral part of the platform construct, as well as processing, storage, and other basic and extended services.

The extensible space platform 200 is based upon a plug and play construct. Using an open systems defined interface control document (ICD) to describe data, power, and instrument interfaces between the payload and the extensible space platform 200 allows quick sensor-to-spacecraft integration.

A size of the PDV 602 and the payload 604, and the resulting PDV-A600, can be selected based on specified launch criteria. For example, the payload delivery vehicle assembly 600 can be sized to fit a standard 12 U CubeSat volume dispenser. If the PDV 602 comprises a 4 U volume, customers can design their payloads 604 to have an 8 U volume such that the combined volume fits the 12 U dispenser. Other suitable sizes can be utilized, and the components can be sized to fit the specifications of any suitable launch vehicle and/or dispenser.

The PDV-A 600 is loaded in a dispenser. The dispenser is then attached to a launch vehicle (for example, a rocket) that places the payload delivery vehicle 600 into an earth orbit near a deployed extensible space platform 200. Once on orbit, a door on the dispenser is opened by an electric signal, and a spring within the dispenser ejects the PDV-A 600 into space. The PDV-A 600 may be loaded into a launch vehicle without use of a dispenser and may be ejected from the launch vehicle in orbit via any suitable actuation.

Computer-controlled commands operate the propulsion system 106 of the PDV 602 to maneuver the PDV-A 600 to a docking position with the extensible space platform 200.

If a payload is deployable, computer-controlled commands deploy the payload from the PDV 604 into its operating configuration. Deployment of the payload 604 may occur prior to or during maneuvering of the PDV-A 600 to the docking position, once at the docking position, or after docking with the extensible space platform 200.

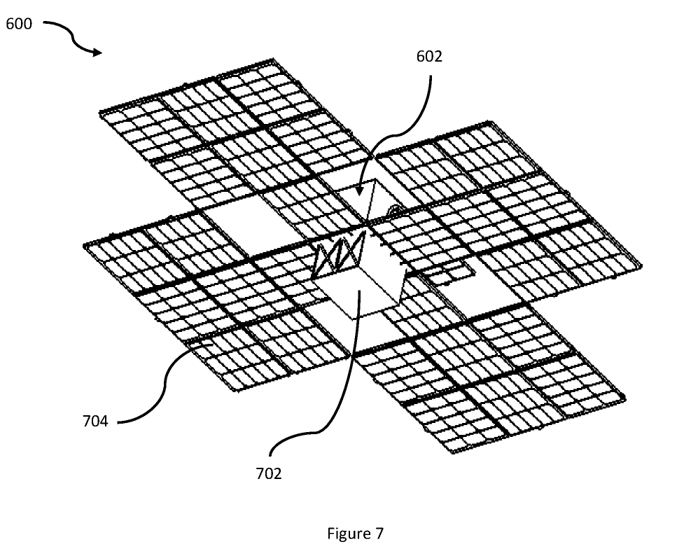

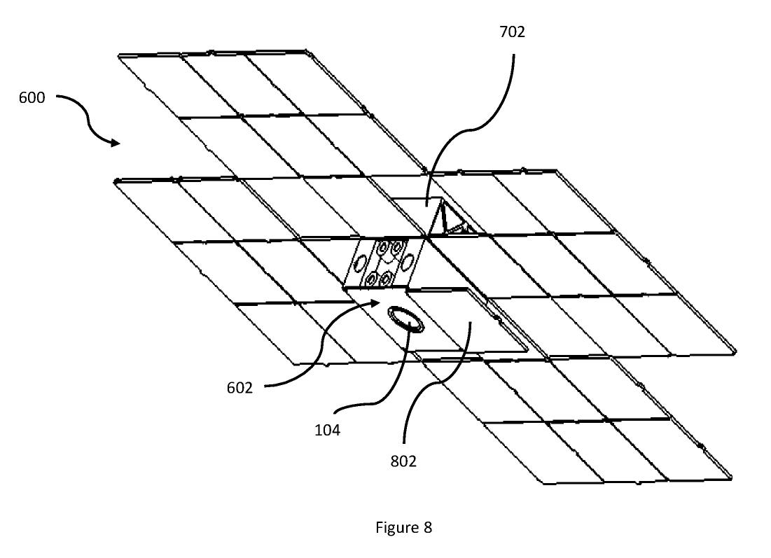

FIG. 7 depicts a sun-side view of a deployed payload 604 of a PDV-A 600 that is a power storage, generation, and communication enhancement to an extensible space platform 200, in accordance with certain examples. FIG. 8 depicts an earth-side view of the deployed payload 604 of the PDV-A 600 that is a power storage, generation, and communication enhancement to an extensible space platform 200, in accordance with certain examples. The payload 604 comprises a battery and radio housing 702 in which the system's batteries and radios are disposed. The payload 604 also comprises a deployed solar array 704 and a phased array down link antenna 802, which were previously in a stowed configuration for launch. As depicted in FIGS. 7 and 8, this payload 604 is designed for an anti-nadir side of the extensible space platform 200. Accordingly, the docking port 104 of the PDV 602 (FIG. 8) will dock with an anti-nadir docking port 104 on the extensible space platform 200.

The payload 604 can be any payload desired by a customer or the extensible space platform owner/operator. The customer/operator can design the payload to interface with the PDV 602 and to utilize the networked systems/components of the PDV 602 and the extensible space platform 200. Example payloads include solar arrays, communication antennas, telescopes, cameras, replacement or enhanced computers, replacement or enhanced attitude control systems, replacement or enhanced batteries, replacement or enhanced orbital maneuvering rockets or ion thrusters, dispensable guided vehicles, synthetic aperture radars, weather sensing instruments, magnetometers, deployable or fixed decoys, defensive payloads, and orbital environment instruments.

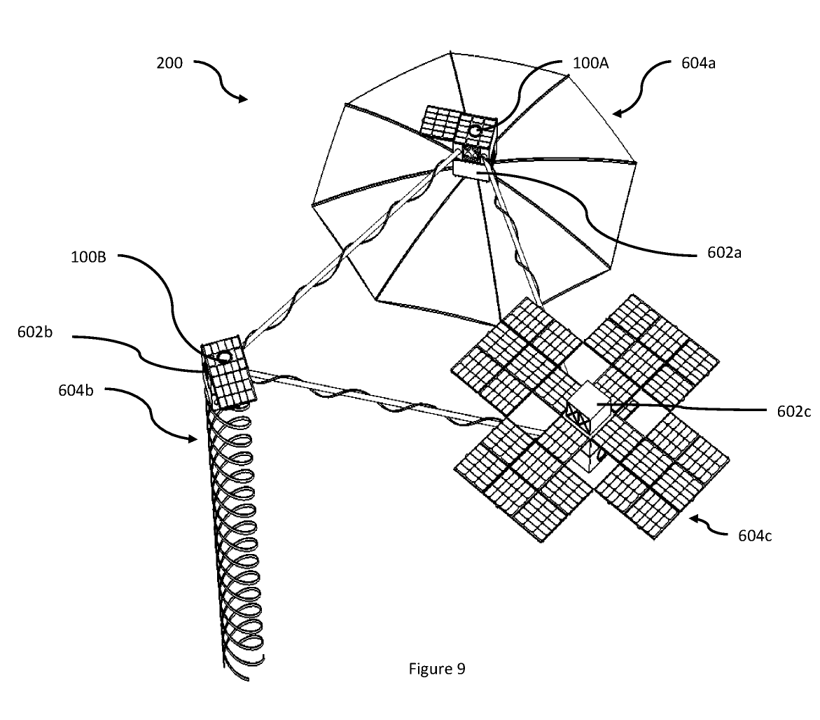

FIG. 9 depicts three payloads 604 docked to an extensible space platform 200, in accordance with certain examples. As shown, the payloads 604 comprise a 2-meter antenna 604a, a 5-meter quadrifilar helix antenna 604b, and a power generation, power storage, and communication payload 604c. Payloads 604a and 604b are docked to the nadir docking port 104a (FIG. 1B) of respective modules 100A-B of the extensible space platform 200. Payload 604c is docked to the anti-nadir docking port 104c (FIGS. 1A and 1B) of module 100C of the extensible space platform 200.

The 2-meter antenna payload 604a and the 5-meter quadrifilar helix antenna payload 604b are “customer” payloads attached to the extensible space platform 200. The customers rent space on the extensible space platform 200 to dock and operate their payloads 604a, 604b. The payloads 604a, 604b utilize the systems/components of the extensible space platform 200, including the systems/components provided by the payload 604c.

As depicted in FIG. 9, the extensible space platform 200 can be upgraded in orbit by the addition of new payloads (such as the payload 604c) to provide enhanced capabilities for the extensible space platform 200. The power generation, power storage, and communication payload 604c provides enhanced power generation, power storage, and communication capabilities to the extensible space platform 200. Other payloads 604 can provide other upgrades or enhancements to the extensible space platform 200. For example, a payload having upgraded computer processing and memory can be docked to the extensible space platform 200 to provide updated computer processing and memory to the extensible space platform 200 and to any payload docked to the extensible space platform 200.

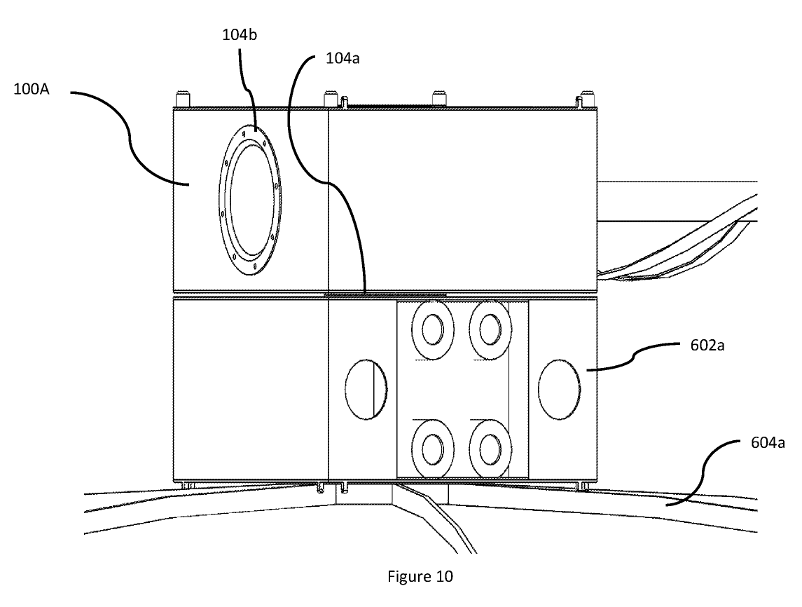

FIG. 10 depicts docking of a single payload delivery vehicle assembly, comprising the customer payload 604a and the payload delivery vehicle 602a to the docking port 104a of the module 100A of an extensible space platform 200, in accordance with certain examples.

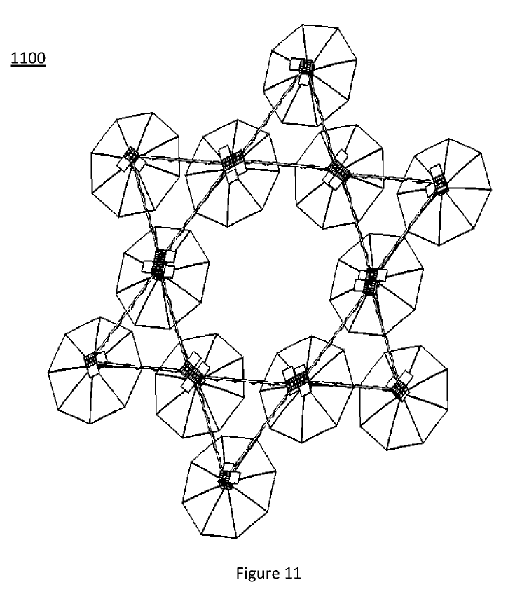

FIG. 11 depicts docking of multiple extensible space platforms 200 together to create a larger space platform 1100, in accordance with certain examples. As shown, six extensible space platforms 200 are docked together to create the larger space platform 1100. Although each payload on the modules of the extensible space platforms 200 is shown as an antenna in FIG. 11, any suitable combination of payload types can be utilized. Additionally, any desired number of two or more extensible space platforms 200 can be connected to create a larger space platform. Although the connected extensible space platforms 200 are depicted as coplanar in FIG. 11, the extensible space platforms 200 can be configured in a three-dimensional arrangement by rotating the extensible space platforms 200 with respect to each other. Multiple extensible space platforms 200 can be linked together by docking at least one module of a first extensible space platform 200 to at least one module of a second extensible space platform 200 via the docking ports provided on the modules. Extensible space platforms 200 may be linked horizontally in the same plane by docking via docking ports in the horizontal plane of the extensible space platforms 200. Additionally, extensible space platforms 200 may be linked vertically by stacking the extensible space platforms 200 using the docking ports on the top or bottom of various modules. The extensible space platforms 200 may also be linked horizontally and vertically in a single system.

In addition to the other benefits described herein when linking multiple extensible space platforms 200, linked extensible space platforms 200 can provide additional structural strength to the system. Two vertically stacked extensible space platforms 200 or other three-dimensional arrangement of combined extensible space platforms 200 provide a stronger structure. As shown in FIG. 11, the extensible space platforms 200 are linked to provide structural integrity for the entire system. Any suitable configuration of extensible space platforms 200 can be configured to desired specifications.

To create the larger space platform 1100, a first extensible space platform 200 is deployed. Then, a second extensible space platform 200 is deployed, maneuvered to the first extensible space platform 200, and docked to one or more modules of the first extensible space platform 200. This process is repeated for subsequent extensible space platforms 200 until the desired configuration of the larger space platform 1100 is achieved.

Another extensible space platform 200 can be added to an existing space platform at any time. Additionally, another extensible space platform 200 can be added to provide upgraded/enhanced technology and systems/components to be utilized by all extensible space platforms 200 and/or payloads attached to the larger space platform.

When two extensible space platforms 200 are connected, each extensible space platform 200 and any payloads attached thereto can utilize all systems and components of connected extensible space platforms 200 and payloads.

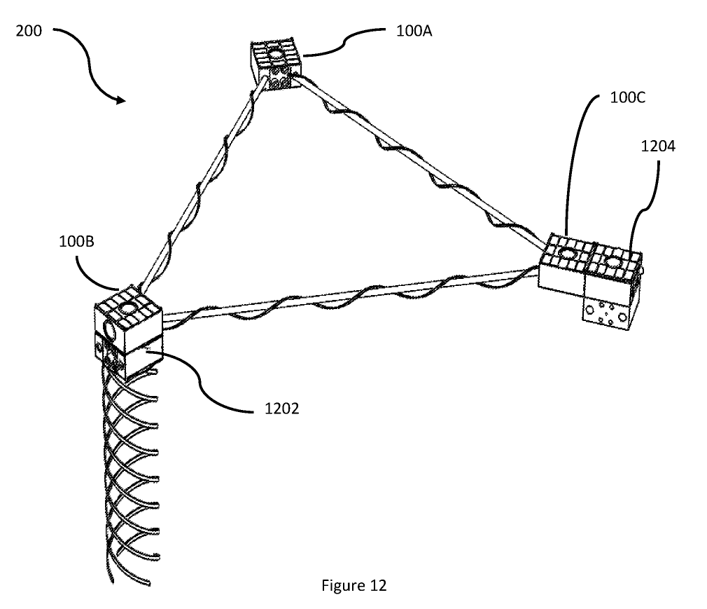

Payload replacement on an extensible space platform 200 will now be described with reference to FIGS. 12-15. FIGS. 12-15 depict a sequence of maneuvering payloads to replace a payload on orbit with a standby payload that is also on orbit, in accordance with certain examples.

In FIG. 12, an operational payload 1202 is docked to module 100B of an extensible space platform 200. Additionally, a standby payload 1204 also is docked to module 100C of the extensible space platform 200. The standby payload 1204 may be docked to any docking port of the module 100C of the extensible space platform 200. However, as a standby payload, the standby payload 1204 typically is docked to the anti-nadir or the exterior docking port of the module 100C. The standby payload 1204 could be docked to the nadir docking port of the module 100C, but another operational payload can be docked at that location instead.

It is desired to replace the operational payload 1202. For example, the operational payload 1202 failed and is not capable of performing its mission, the operational payload 1202 completed its designed mission, the operational payload 1202 reached the end of its useful life, or the tenant renting the docking port space to operate the operation payload 1202 on the extensible space platform 200 does not want to continue to rent that space (or the lease agreement has otherwise terminated). Regardless of the reason, the operational payload 1202 will be replaced.

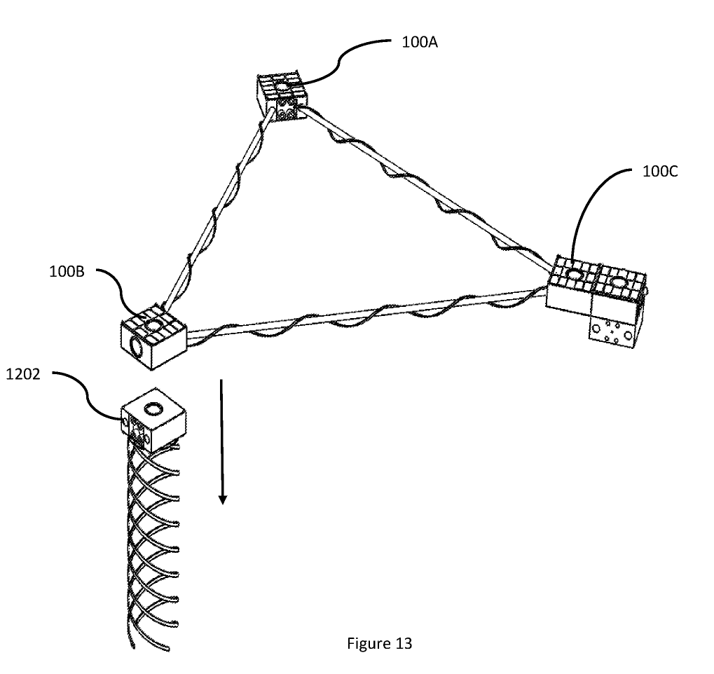

As shown in FIG. 13, the PDV-A comprising the operational payload 1202 is ejected from the extensible space platform 200 in the direction of the arrow. The docking procedure described previously may be reversed to eject the operational payload 1202. For example, the mechanical fasteners or magnetic latching holding the PDV-A comprising the operational payload 1202 docked to the extensible space platform 200 may be released. Then, the electromagnet of the module 100 of the extensible space platform 200 and/or of PDV-A comprising the operational payload 1202 may be actuated with a reverse polarity to repel the operational payload 1202 from the extensible space platform 200. In this manner, the PDV-A comprising the operational payload 1202 is ejected in a direction away from the extensible space platform 200. If desired, the propulsion system 106 of the payload delivery vehicle of the PDV-A comprising the operational payload 1202 can be operated to maneuver the PDV-A comprising the operational payload 1202 away from the extensible space platform 200 or to a desired location.

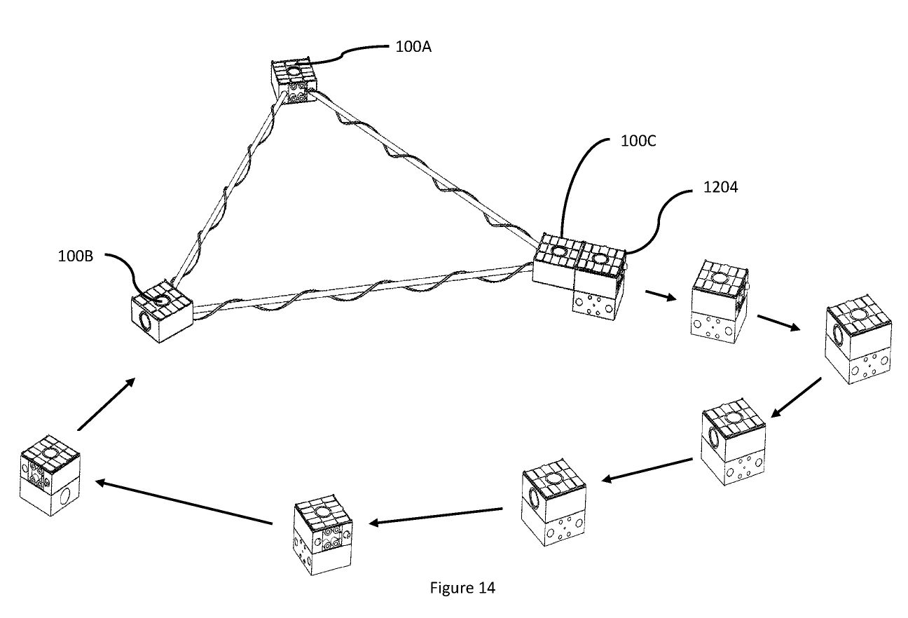

As shown in FIG. 14, the PDV-A comprising the standby payload 1204 is maneuvered from its standby location on module 100C of the extensible space platform 200 to the operational location on module 100B of the extensible space platform 200. The PDV-A comprising the standby payload 1204 is ejected from the docking port of module 104C in a manner similar to ejection of the PDV-A comprising the operational payload 1202 described previously. Then, the propulsion system 106 (FIGS. 1 and 6) of the PDV-A comprising the standby payload 1204 is engaged to maneuver the PDV-A comprising the standby payload 1204 into docking position with the nadir docking port of module 100B of the extensible space platform 200. The docking procedure is executed to dock the PDV-A comprising the standby payload 1204 to the module 100B of the extensible space platform 200.

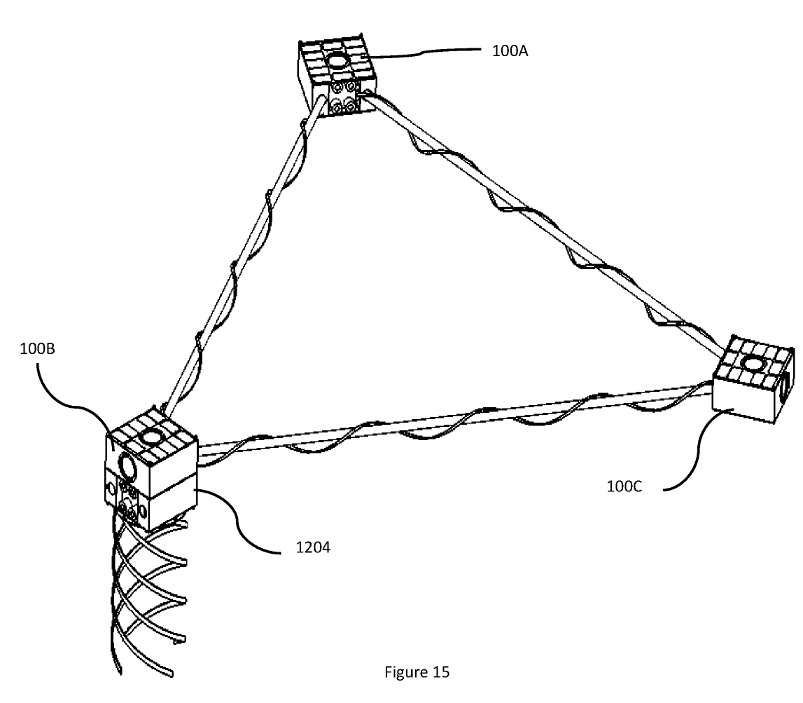

As shown in FIG. 15, the antenna of the standby payload 1204 is deployed, and the standby payload 1204 becomes operational.

This payload replacement procedure provides rapid replacement of an existing payload. For example, the standby payload 1204 can be a direct replacement of an operational payload 1202. If the operational payload 1202 fails, it can be ejected and replaced with the standby payload 1204. In this manner, the failed payload is replaced quickly, within a matter of hours or days. In conventional systems, replacing a failed system in orbit would take many months or years, even if a replacement is ready for launch. While the operator is finding space on a launch vehicle and scheduling a launch, the failed payload remains out of operation for many months or years.

This payload replacement procedure also provides routine replacement of an existing payload. For example, if a tenant renting the payload space on the extensible space platform 200 desires to terminate a lease agreement (or the lease reaches its end of life), the extensible space platform 200 operator can replace the current operational payload with a standby payload of another tenant. In this manner, the docking ports of the extensible space platform 200 remain in use with less down time.

The payload replacement procedure also simplifies payload launch scheduling and improves use of launch vehicles. For example, if a launch vehicle has available/unused space for a scheduled launch, a standby payload can be included in the launch vehicle, transported to orbit, and docked in the standby position of the extensible space platform 200. In this manner, a reduced cost for launch may be provided to utilize available space on the launch vehicle, even though the standby payload did not need to be launched until a later date. Then, the standby payload can be shifted to the operational position on the extensible space platform 200 at a desired time.

Disaggregation and reaggregation of an extensible space platform 200 will now be described. Disaggregation refers to ejecting one or more payloads from the extensible space platform 200, maneuvering the payloads and/or the extensible space platform to a different location, and redocking the one or more payloads to the extensible space platform either at the original location or at another location.

When desired, the ejection sequence is followed for one or more of the attached payloads to eject the payloads from the extensible space platform. Then, the propulsion systems of the payloads (for the corresponding PDV-As) and the extensible space platform are operated to maneuver the payloads and the extensible space platform from their original location. The propulsion system(s) of the extensible space platform are engaged to maneuver the extensible space platform to a specified location or orientation. The propulsion system of an ejected payload's attached PDV is engaged to maneuver the ejected payload to a specified module of the extensible space platform, and the docking procedure is executed to dock the ejected payload to the specified module. This redocking procedure is followed until all ejected payloads are redocked with the extensible space platform. If multiple extensible space platforms were docked together, the disaggregation and reaggregation procedure is followed to undock the extensible space platforms, eject their payloads, redock the extensible payloads, and redock the ejected payloads.

This disaggregation and reaggregation procedure is valuable to maneuver the extensible space platform and its payloads. For example, if the extensible space platform needs to move to a new orbit/position for further operation of the extensible space platform or one or more of the docked payloads, this disaggregation and reaggregation procedure accomplishes that move. Or, if space debris or other danger threatens the extensible space platform, disaggregation and reaggregation procedure can maneuver the extensible space platform and its payloads out of harms way until the danger passes, at which time the extensible space platform is maneuvered to an operational position and redocked together.

The extensible space platform described herein can comprise multiple modules 100 connected by an extensible framework. In its simplest form, a main module can comprise the propulsion system 106, processors/computer systems 108, deployable solar array 110, power source 112, and wiring harness 116. Secondary modules may comprise only the docking ports 104 and the wiring harness 116. Other components may be added to those secondary modules as desired. Additionally, the secondary modules may have a limited housing such as a support plate comprising one or more docking ports to which payloads can be docked.

Because the extensible space platform described herein allows the addition of multiple sensors to the collective group, this concept enables the simultaneous coincidental collection of multiple phenomenologies, such as Synthetic Aperture Radar and electro-optical and infra-red (EO/IR) data. To adequately process and reference multiple phenomenologies, such as radar and EO, the system finds the exact correspondence between different types of images and between these images and the existing maps. In other words, the system will reference these images. Simultaneous collection using different sensors on the extensible space platform describe herein is made possible by adjustable elements of composite tapes, other extensible framework between the spacecraft, or gimbals integrated into the construct of the PDV and the payload assembly which allows multiple sensors to be pointed at the same spot on the ground simultaneously. Additionally, the built in integrated network, power and communications allows the multiple different sensors to be synchronized by a single master clock, simplifying data processing, alignment, and coherence. Because relative and absolute positions of all elements on the extensible space platform described herein are known, including the sensors, therefore absolute data coherence. Thus, true multispectral collection between radar, EO/IR, and other phenomenologies can be achieved in space from a single spacecraft.

The extensible space platform described herein uses a software-defined network (SDN) as its backbone network infrastructure. This open architecture construct is dynamic, manageable, cost-effective, adaptable, and suitable for the high-bandwidth, dynamic nature of the space platform's multiple appliances and applications. Because a SDN architecture decouples network control and forwarding functions, it allows network control to be directly programmable and the underlying infrastructure to be abstracted from applications and network services. This architecture allows the configuration, management, security, and optimization of network resources quickly using a dynamic, automated proprietary or non-proprietary software. This simple dynamic network allows control over new applications, devices, and sensors, as well as fungible network, interfaces, and devices.

The high speed local area network of the extensible space platform described herein allows sensors to access built in flash (solid state) storage arrays or other storage media. This architecture with current multi-core, multi-threaded CPUs allows complex on-orbit processing and machine learning applications to execute near-real time decision engines and transaction level block-chain style encryption on-orbit. Processes, transactions, and data can be isolated (Geo-Fenced) through the use of trusted processing modules and block-chain, type 1, or other encryption techniques while at rest and in motion to ensure the integrity, lineage, confidentiality, and quality of data.

The software defined network also allows better control over the data paths, control plane, and applications. Additionally, it facilitates the upgrade, retrofit, and resilience of the entire platform and network. One aspect of this control is the ability to upgrade the CPUs on the network through the retrofitting or repair process, thereby making network processors fungible, for example, by docking an upgraded PDV to the extensible space platform. The extensible space platform described herein is a resilient and renewable data and processing center in space.

The design describe herein can reduce time to market significantly, and can lower the upfront costs through the application of service level agreements and other leasing options. Also, technical risks and time-to-orbit can be reduced through the reutilization of well-defined specifications. The extensible space platform described herein reduces failure risk, technical risks, and insurance costs, while lengthening overall mission capabilities. The extensible space platform described herein manages these risks due to simple well-defined interfaces, preflight testing using an on-orbit physical model, preapproved or in-use licenses, and a well-defined assembly system. In the next few years, space “real estate” is going to become critical to the success of future missions. The extensible space platform described herein mitigates this risk for customers by providing a leasable spot on a miniature space platform for their instrument or payload to reside during its operational life. Once under contract, the tenant company has only to meet defined engineering requirements for their payload or instrument and turn it over to the leasing company for delivery on orbit. The leasing company will manage everything from this point forward up to and including the delivery of the data to the customer on the ground. This includes integrating the payload and securing it to a specialized “Payload Delivery Vehicle” spacecraft (PDV), such as described with reference to FIG. 6, managing launch, and other on orbit aspects.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, an ordinarily skilled programmer would be able to write such a computer program to implement an embodiment of the disclosed embodiments based on the drawings and description provided herein. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and components described in the embodiments presented previously are illustrative, and, in alternative embodiments, certain components can be combined in a different order, omitted entirely, and/or combined between different example embodiments, and/or certain additional components can be added, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A space platform system, comprising:
three modules, each of the modules comprising a docking port, and at least one of the modules comprising a propulsion system, a deployable solar array, a power distribution system, a communication system, and a computing system;
an extensible structural framework connecting the three modules, wherein each of the three modules is structurally connected to the other two modules via the extensible framework; and
a data and power circuit that creates a local area network between the modules, wherein the data and power circuit is coupled to the docking port of each of the modules and to the propulsion system, the deployable solar array, the power source, and the computing system of each such equipped module,
wherein the extensible structural framework is operable to extend the extensible space platform from a retracted position for launch in which the modules are close together to an extended position for operation in space in which the extensible structural framework has moved the modules away from each other.

2. The space platform system according to claim 1, wherein the modules are arranged in a stacked configuration in the retracted position for launch.

3. The space platform system according to claim 1, wherein the modules are arranged in a triangular configuration in the extended position for operation in space.

4. The space platform system according to claim 1, wherein the extensible structural framework comprises a plurality of tape deployment apparatuses comprising structural tapes that connect the three modules.

5. The space platform system according to claim 4, wherein, for each module of the three modules, a tape deployment apparatus is housed in the module and a corresponding structural tape extends from the tape deployment apparatus housed in the module to another one of the three modules.

6. The space platform system according to claim 4,
wherein the modules comprise module A, module B, and module C,
wherein the structural tape (“tape AC”) of the tape deployment apparatus housed in module A extends to and connects with module C,
wherein the structural tape (“tape BA”) of the tape deployment apparatus housed in module B extends to and connects with module A, and
wherein the structural tape (“tape CB”) of the tape deployment apparatus housed in module C extends to and connects with module B.

7. The space platform system according to claim 6,
wherein, in the retracted position for launch, the modules A, B, and C are latched together and stacked in an order of module C, module A, and module B from bottom to top,
wherein the latches release to release the modules A, B, and C from the stacked position and the tape AC extends to push module C away from the module A, the tape BA extends to push module A away from the module B, and the tape CB extends to push the module B away from the module C.

8. The space platform system according to claim 7, further comprising a lanyard that connects an extending end of the tape CB to module B when the modules are in the stacked position,
wherein, after the latches release to release the modules A, B, and C from the stacked position, the lanyard is retracted into module B to pull the tape CB into module B and thereafter the tape CB extends to push the module B away from the module C.

9. The space platform system according to claim 1, wherein the extensible structural framework comprises a plurality of extensible mast assemblies.

10. The space platform system according to claim 9,
wherein the modules comprise module A, module B, and module C,
wherein one of the extensible mast assemblies connects module A to module B,
wherein one of the extensible mast assemblies connects module B to module C, and
wherein one of the extensible mast assemblies connects module C to module A.

11. The space platform system according to claim 1, further comprising:
a payload delivery vehicle assembly that is initially separated from the extensible space platform, the payload delivery vehicle assembly comprising:
a payload that is initially in a stowed position for launch; and
a payload delivery vehicle coupled to the payload and comprising a propulsion system, a data and power circuit, and a docking port,
wherein the propulsion system of the payload delivery vehicle is operable to maneuver the payload delivery vehicle assembly in proximity to the space platform to dock the payload delivery vehicle assembly to the space platform via the docking port of the payload delivery vehicle and the docking port of one of the modules of the space platform,
wherein docking the docking port of the payload delivery vehicle and the docking port of one of the modules of the space platform connects the data and power circuit of the payload delivery vehicle of the payload delivery vehicle assembly to the data and power circuit of the extensible space platform forming a local area network such that the payload of the payload delivery vehicle assembly utilizes at least the power source and the computing system of the extensible space platform, and
wherein the payload is operable to reconfigure from the stowed position to an operational position, to operate the payload when docked to the extensible space platform.

12. The space platform system according to claim 11, wherein docking the payload delivery vehicle assembly to the extensible space platform creates a local area network between the systems providing access for the payload to systems and components of the extensible space platform and any other payload docked to the extensible space platform.

13. The space platform system according to claim 11, further comprising:
two additional payload delivery vehicle assemblies that dock to respective ones of the other two modules of the extensible space platform.

14. The space platform system according to claim 1, further comprising a second additional space platform docked to the docking port of the extensible space platform of claim 1.

15. The space platform system according to claim 1, wherein at least one of the modules further comprises at least one of an attitude control system and a timing system,
wherein the data and power circuit is further coupled to the attitude control system and the timing system of each such equipped module.

16. A payload delivery vehicle assembly that is initially separated from an extensible space platform, comprising:
a payload that is initially in a stowed position for launch; and
a payload delivery vehicle coupled to the payload and comprising a propulsion system, a data and power circuit, and a docking port,
wherein the propulsion system of the payload delivery vehicle is operable to maneuver the payload delivery vehicle assembly in proximity to the space platform in space to dock the payload delivery vehicle to the space platform via the docking port of the payload delivery vehicle and a docking port of the space platform,
wherein docking the docking port of the payload delivery vehicle and the docking port of the space platform connects the data and power circuit of the payload delivery vehicle of the payload delivery vehicle assembly to a data and power circuit of the space platform creating a local area network such that the payload of the payload delivery vehicle assembly utilizes at least a power source and a computing system of the space platform, and
wherein the payload is operable to reconfigure from the stowed position to an operational position, to operate the payload when docked to the space platform.

17. A method to deploy an extensible space platform system, comprising:
providing an extensible space platform in a stowed configuration for launch, the extensible space platform, comprising:
three modules, each of the modules comprising a docking port, and at least one of the modules comprising a propulsion system, a deployable solar array, a power distribution system, a communication system, and a computing system,
an extensible structural framework connecting the three modules, wherein each of the three modules is structurally connected to the other two modules via the extensible framework, and
a data and power circuit creating a local area network, wherein the data and power circuit is coupled to the docking port of each of the modules and to the propulsion system, the deployable solar array, the power source, and the computing system of each such equipped module;
launching the extensible space platform in the stowed configuration via a launch vehicle;
operating the propulsion system of the extensible space platform to maneuver the extensible space platform; and
extending the extensible structural framework to reconfigure the extensible space platform from the retracted position for launch in which the modules are close together to an extended position for operation in space in which the extensible structural framework has moved the modules away from each other.

18. A method to replace a payload on a space platform, comprising:
providing a space platform in orbit;
docking an operational payload vehicle delivery assembly comprising an operational payload to a first docking port of the space platform;
docking a standby payload vehicle delivery assembly comprising a standby payload to a second docking port of the space platform;
undocking the operational payload vehicle delivery assembly from the first docking port of the space platform;
undocking the standby payload vehicle delivery assembly from the second docking port of the space platform;
maneuvering the standby payload vehicle delivery assembly in proximity to the first docking port of the space platform;
docking the standby payload vehicle delivery assembly to the first docking port of the space platform; and
deploying the standby payload to an operational configuration.

19. The method according to claim 18, wherein the operational payload and the standby payload perform similar missions.

20. The method according to claim 18, wherein the operational payload and the standby payload perform different missions.

21. A method to disassemble and reassemble a space platform, comprising:
providing a space platform in orbit, the space platform comprising a plurality of docking ports and having a plurality of payload vehicle delivery assemblies docked to respective ones of the docking ports of the space platform;
ejecting the payload vehicle delivery assemblies from the docking ports of the space platform;
maneuvering, via a propulsion system on each of the payload vehicle delivery assemblies, the payload vehicle delivery assemblies to other locations in space;
maneuvering the space platform to another location in space;
maneuvering the space platform back to the orbit;
maneuvering each of the payload vehicle delivery assemblies in proximity to the space platform; and
redocking the payload vehicle delivery assemblies to the space platform.

22. The method according to claim 21, further comprising:
undeploying each of the payload vehicle delivery assemblies to a stowed state prior to ejecting the payload vehicle delivery assemblies from the docking ports of the space platform; and
redeploying each of the payload vehicle delivery assemblies to an operational state after redocking the payloads to the space platform.
